(19) United States
(12) Patent Application Publication
(10) Pub. No.: US 2007/0244763 A1
(43) Pub. Date: Oct. 18, 2007

(54) Method of establishing templated websites for compiling and storing preselected information

(75) Inventors: Russell A. Williams, Murrysville, PA (US); Eric M. Zalevsky, Pittsburgh, PA (US)

Correspondence Address: JAMES RAY & ASSOCIATES, 2640 PITCAIRN ROAD, MONROEVILLE, PA, 15146, US

(73) Assignee: JACOB ENTERPRISES, INC.

(21) Appl. No.: 10/883,954

(22) Filed: Jul. 1, 2004

Related U.S. Application Data
(60) Provisional application No. 60/483,865, filed on Jul. 1, 2003.

(51) Int. Cl. G06Q 30/00

(52) U.S. Cl. 705/26

(57) ABSTRACT

A method for establishing templated websites for compiling, storing and accessing preselected subject information. The method comprises the steps of establishing a data base having a predetermined number of separate fields and establishing at least one portfolio website. The method includes the step of utilizing at least one template having separate fields for inserting relevant information for at least one subsequent preselected use, the at least one template incorporating all of the relevant information related to such preselected subject information. The method includes the step of providing a user identification and/or a password for enabling a user to access the preselected subject information compiled and stored in an online management system.

### CROSS REFERENCE TO RELATED APPLICATIONS

This application is closely related to and claims benefit from U.S. Provisional Application Ser. No. 60/483,865 filed Jul. 1, 2003.

### FIELD OF THE INVENTION

The present invention relates, in general, to a method for compiling, storing and accessing information and, more particularly, the present invention relates to a method for creating templated websites with product information stored therein for presenting such product ideas to interested third parties.

### BACKGROUND OF THE INVENTION

One problem that is constantly encountered in dealing with inventions that have been conceived by individuals that are working alone is in trying to bring the invention to fruition. The idea and/or invention may be a very useful idea and could very well lead to a patent. However, the patent in itself, although possibly self fulfilling, does not guarantee that the idea can lead to a useful and marketable product.

It is difficult for an individual to be able to take an idea and develop a successful way of producing and marketing a product resulting from that idea and thereby give the inventor a return on his invention. Individuals have a difficult time in reaching the people, or companies, that have the knowledge and financial resources to take the idea and develop it into a product that is marketable.

Similarly, the process of receiving ideas/inventions from individual inventors can be daunting and cumbersome even for companies whose business is receiving such ideas and marketing these ideas. The individual inventor usually sends unorganized, unprofessional and unsolicited ideas to the prospective company in hopes of a review and subsequent license agreement.

Prior to the present invention, tradeshows have been used to bring inventors, agents, manufacturing representatives, brokers, marketing representatives and the like together so that these various aspects could come together to determine if there was any interest in the ideas presented. However, these tradeshows require that there be some organization that would set up the show and make all of the arrangements for the show. This can lead to expenses which would have to be paid by the participants in the tradeshow. Further, all of these parties would have to travel to the same location, which would probably be an exposition area such as a large arena. Thus, there are considerable travel expenses involved along with lodging expenses and all the incidentals that go with travel. This can be a rather large expense for an individual inventor who may have limited resources and probably prevents many inventors from attending tradeshows.

There is a need for a better method of providing individual inventors with a way to present their invention in an organized and professional manner and equally as well there is a need for prospective manufacturing representatives, brokers, marketing representatives, agents and the like to be able to review and evaluate many such ideas/inventions easily and quickly.

### SUMMARY OF THE INVENTION

The present invention provides a method for establishing templated websites for compiling, storing and accessing preselected subject information. The method comprises the steps of establishing a data base having a predetermined number of separate fields and establishing at least one portfolio website. The method includes the step of utilizing at least one template having separate fields for inserting relevant information for at least one subsequent preselected use, the at least one template incorporating all of the relevant information related to such preselected subject information. The method includes the step of providing a means for enabling a user to access the preselected subject information compiled and stored in an online management system.

Another embodiment of the invention provides a method for presenting a predetermined plurality of product designs as an online tradeshow using portfolio websites for compiling, storing and accessing preselected subject information. The method comprises the steps of establishing a database having a predetermined number of separate fields for receiving relevant information therein and entering the relevant information into the separate fields. The method includes the step of establishing a predetermined plurality of portfolio websites and utilizing at least one template having the separate fields with relevant information inserted therein for at least one subsequent preselected use, and selecting a predetermined number of portfolio websites for viewing online utilizing relevant information within the separate fields.

### OBJECTS OF THE INVENTION

It is, therefore, one of the primary objects of the present invention is to provide an invention portfolio site for compiling and storing all relevant information.

Another object of the present invention is to provide a standard, consistent and repeatable method for storing such relevant information.

Still another object of the present invention is to provide a method wherein the process of communicating information is simplified in an electronic format.

Yet another object of the present invention is to provide a method wherein review and evaluation of information is performed quickly and easily.

Another object of the present invention is to provide a method wherein potentially interested third parties can access the templated websites containing product design.

Still another object of the present invention is to provide an online tradeshow so that third parties can properly evaluate ideas/inventions.

It is another object of the present invention to provide a virtual product design based the entered relevant information.

It is yet another object of the present invention to provide a virtual prototype based the entered relevant information.

Another object of the present invention is to provide a invention portfolio site for compiling and storing all relevant information that is cost effective compared to existing methods.

Still another object of the present invention is to provide a method for compiling and storing all relevant information that has controlled access.

Yet another object of the present invention is to provide a invention portfolio site for compiling and storing all relevant information a plurality of individual user websites are connected to a master website.

In addition to the numerous objects and advantages of the present invention which have been described with some degree of particularity above, it should be both noted and understood that a number of other important objects and advantages of the invention will become more readily apparent to those persons who are skilled in the relevant art of furniture moving from the following more detailed description of the invention, particularly, when such detailed description is taken in conjunction with the appended claims.

### BRIEF DESCRIPTION OF THE PRESENTLY PREFERRED AND VARIOUS ALTERNATE EMBODIMENTS OF THE PRESENT INVENTION

Although the invention will be described in conjunction with compiling information related to inventions it should be recognized by persons skilled in the art that the process has numerous applications beyond those of inventions.

The present invention, according to a presently preferred embodiment, provides a method for establishing templated websites. Such templated websites are used for compiling, storing and accessing preselected subject information.

The method includes the steps of establishing a database having a predetermined number of separate fields. There is at least one portfolio website established. The method contemplates utilizing at least one template having such separate fields for inserting relevant information thereon. Such relevant information having at least one subsequent preselected use. It should be noted that such at least one template can incorporate all of such relevant information relating to such preselected subject information thereon. Finally there is provided a means for enabling a user to access the preselected subject information compiled and stored in an online management system.

In a presently preferred embodiment, such preselected subject information includes at least one of ideas and inventions.

At least one of the subsequent preselected uses may be designing a product, and the method includes the additional step of establishing a virtual product design based on such relevant information. The virtual product design is a two-dimensional model of the product. Another at least one subsequent preselected use can be, for example, producing a virtual prototype, and such method includes the additional step of developing a virtual prototype based on a product design. The virtual prototype is preferably a three-dimensional model of the product.

Such database, portfolio website, and online management system are established on at least one computer that is in communication with the internet. Such template is a webpage of the portfolio website, and information is entered into the separate template fields either directly from at least one of the computer(s) where the website has been established, or by users of the website with proper access using a computer in communication with the website via an internet connection. The relevant information entered into these fields is then stored into the separate fields of the database. The template and portfolio website are subsets of the online management system, which may further include another webpage known to one skilled in the art as a “home page”, and such home page will be linked to the database, template, portfolio website, online management system, and be able to be accessed via the internet.

Users of the website with the proper access are able to access their portfolio webpage to make changes to the relevant information previously entered into the fields and stored into the database. Such proper access may be a user identification and/or a password. Once relevant information is entered into the fields, users with proper access can then view another webpage of the website that shows the information entered into the database. This portfolio webpage is based on a template, and extracts the specific users preselected subject information from the database and automatically inserts such preselected subject information into specific fields contained within the webpage template. The portfolio webpage will also display at least one of the virtual product design and virtual prototype on such portfolio webpage if they have been created for use with such portfolio webpage. Other images types may also be displayed on the portfolio website either in addition to or instead of the virtual product design or virtual prototype.

Once a user has completed entering information into the database, and if available, at least one of the virtual product design and virtual prototype and other image types have been placed in the database, the availability of such user's portfolio website is made available to prospective users. Such users are provided an interface means for accessing the user's portfolio website. In a presently preferred embodiment, such interface means is a webpage field linking said webpage field to said portfolio website. Such interface means may also be a link sent via electronic mail.

The method includes the additional step of providing access of potentially interested parties to at least one templated portfolio website. These potentially interested parties are selected from at least one of users, manufacturers and marketers of said product design. Such potentially interested parties are provided an interface means for accessing the user's portfolio website. In a presently preferred embodiment, such interface means is a webpage field linking such webpage field to such portfolio website. Such interface means may also be a link sent via electronic mail. For certain users, access to such preselected subject information requires such user to enter the proper one of at least one of a user identification and a password.

The method includes the additional step of communicating to potentially interested parties the product design, such potentially interested parties selected from at least one of users, manufacturers and marketers of such product design. For certain potentially interested parties, access to such preselected subject information requires such potentially interested parties to enter the proper one of at least one of a user identification and a password.

Until now, only a single user having a single portfolio website has been discussed. Obviously, it is possible and desirable to establish a plurality of portfolio websites. Such plurality of portfolio websites will be created in the manner described above. Such plurality of portfolio websites will also be displayed using the templated approach also described earlier, and contain the information described for the single user portfolio website. The availability of this plurality of portfolio websites will be communicated to potentially interested parties, and such potentially interested parties will have access to such plurality of portfolio websites. This plurality of portfolio websites is called an “online tradeshow”.

Potentially interested parties who participate in such online tradeshows are also able to go to another webpage contained within the online management system and select a predetermined number of portfolio websites for viewing online utilizing relevant information within the separate fields contained within such another webpage. Potentially interested parties selected from at least one of users, manufacturers and marketers are enabled to have access to the online trade show for searching and reviewing the portfolio websites. The method of enabling potentially interested parties access to the online trade show may further include inputting at least one of a user identification and a password.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. A method for establishing templated websites for compiling, storing and accessing preselected subject information; said method comprising the steps of:
(a) establishing a database having a predetermined number of separate fields;
(b) establishing at least one portfolio website;
(c) utilizing at least one template having said separate fields for inserting relevant information for at least one subsequent preselected use, said at least one template incorporating all of said relevant information relating to such preselected subject information; and
(d) providing a means for enabling a user to access said preselected subject information compiled and stored in an online management system.

2. The method, according to claim 1, wherein said at least one subsequent preselected use is designing a product and said method includes the additional step of establishing a virtual product design based on said relevant information.

3. The method, according to claim 1, wherein said at least one subsequent preselected use is producing a virtual prototype and said method includes the additional step of developing said virtual prototype based on a product design.

4. The method, according to claim 3, wherein said method further includes the additional step of using said portfolio website established in step (b) with said virtual prototype developed for offering a product design to prospective users.

5. The method, according to claim 1, wherein said method includes the additional step of saving said relevant information inserted into said separate fields in step (c) to a database.

6. The method, according to claim 1, wherein said method includes providing an interface means for accessing said portfolio website.

7. The method, according to claim 6, wherein said interface means for accessing said portfolio website includes the step of linking a website field to said portfolio website.

8. The method, according to claim 2, wherein said method includes the additional step of providing access of potentially interested parties to said at least one templated website containing said product design, said potentially interested parties selected from at least one of users, manufacturers and marketers of said product design.

9. The method, according to claim 2, wherein said method includes the additional step of communicating to potentially interested parties said product design, said potentially interested parties selected from at least one of users, manufacturers and marketers of said product design.

10. The method according to claim 1, wherein step (b) includes establishing a plurality of portfolio websites.

11. The method, according to claim 1, wherein step (b) includes establishing at least one master website and a plurality of individual user websites and said method includes feeding said individual user website from said at least one master website.

12. A method, according to claim 1, wherein said method includes the additional step of entering website content information into an online form and storing said information in a database.

13. The method, according to claim 12, wherein said database feeds said website template.

14. The method, according to claim 12, wherein each time a user selects a template, said method includes the additional steps of enabling said online management system to retrieve at least one of preselected subject information and relevant information stored therein and automatically populating said website template.

15. The method, according to claim 1, wherein said means for enabling a user to access said preselected subject information includes at least one of a user identification and a password.

16. The method, according to claim 1, wherein said preselected subject information includes at least one of ideas and inventions.

17. A method for presenting a predetermined plurality of product designs as an online tradeshow using portfolio websites for compiling, storing and accessing preselected subject information; said method comprising the steps of:
(a) establishing a database having a predetermined number of separate fields for receiving relevant information therein;
(b) entering said relevant information into said separate fields;
(c) establishing a predetermined plurality of portfolio websites;
(d) utilizing at least one template having said separate fields with relevant information inserted therein for at least one subsequent preselected use, said at least one template incorporating all of said relevant information relating to such preselected subject information; and
(e) selecting a predetermined number of portfolio websites for viewing online utilizing relevant information within said separate fields.

18. The method, according to claim 17, wherein said method includes the step of linking said portfolio websites established in step (a) to said online tradeshow.

19. The method, according to claim 18, wherein said method includes the step of enabling potentially interested parties selected from at least one of users, manufacturers and marketers to access said online trade show for searching and reviewing said portfolio websites.

20. The method, according to claim 19, wherein the step of enabling potentially interested parties to access said online trade show further includes the step of inputting at least one of a user identification and a password.
